(19) United States
(12) Patent Application Publication
(10) Pub. No.: US 2025/0018354 A1
(43) Pub. Date: Jan. 16, 2025

(54) THERMAL DECOMPRESSION CONTROL DEVICE FOR GLASS CONTAINERS FOR MAGNETIC FLUID MIXING LIQUID

(71) Applicant: YUNQIN XU, Guangzhou (CN)

(72) Inventor: YUNQIN XU, Guangzhou (CN)

(21) Appl. No.: 18/357,314

(22) Filed: Jul. 24, 2023

(30) Foreign Application Priority Data
Jul. 14, 2023 (CN) 202310864013.2

(51) Int. Cl. B01F 33/45; B01F 35/51

(52) U.S. Cl. CPC B01F 33/45; B01F 35/51

(57) ABSTRACT

A thermal decompression control device for glass containers for magnetic fluid mixing liquid, comprising a glass container, and an inside of the glass container is filled with magnetic fluid mixing liquid. An outer edge of the glass container comprises an extended and protruding cylinder, and the glass container is connected with a soft silicone tube by the cylinder. The soft silicone tube is formed into a hollow cylinder with one end open and the other end sealed, wherein the open end of the soft silicone tube is tightly socketed with the protruding cylinder of the glass container. The protruding cylinder of the glass container is a hollow cylinder communicating with the inside of the glass container. The intersection of the soft silicone tube and the glass is sealed.

### CROSS-REFERENCE TO RELATED APPLICATIONS

This is a U.S. patent application which claims the priority and benefit of Chinese Patent Application Number 202310864013.2, filed on Jul. 14, 2023, the disclosure of which is incorporated herein by reference in its entirety.

### TECHNICAL FIELD

The present application relates to the technical field of glass containers for magnetic fluid mixing liquid, in particular to a thermal decompression control device for glass containers for magnetic fluid mixing liquid.

### BACKGROUND

There are glass containers filled with magnetic fluid mixing liquid on the market, and the magnetic fluid is controlled by the magnetic coil of the electromagnet to generate dancing effect. Because the magnetic coil will generate heat when it is working, the temperature inside the glass container will continue to rise after the glass container is subjected to the temperature conduction of the magnetic coil, which leads to the following problems:
1. Affected by the temperature of the magnetic coil, the internal pressure of the glass container continues to increase. When a certain pressure is reached, the glass container will rupture;
2. Affected by the temperature of the magnetic coil, the internal pressure of the glass container continues to increase, the fluidity of the magnetic fluid controlled by the magnetic coil becomes lower, and the dancing effect of the magnetic fluid becomes worse;

For this reason, the present application proposes a thermal decompression control device for glass containers for magnetic fluid mixing liquid.

### SUMMARY

In order to overcome the deficiencies of the prior art, the present application provides a thermal decompression control device for glass containers for magnetic fluid mixing liquid, wherein, after the temperature of the glass container rises, the glass container will not break, and at the same time realize the magnetic fluid to maintain the original good dancing visual effect.

In order to solve the above technical problems, the present application provides the following technical solutions: A thermal decompression control device for glass containers for magnetic fluid mixing liquid, comprising a glass container, and an inside of the glass container is filled with magnetic fluid and carrier liquid, wherein the magnetic fluid is suspended in the carrier liquid, wherein an outer edge of the glass container comprises an extended and protruding cylinder, and the glass container is connected with a soft silicone tube by the cylinder.

The soft silicone tube is formed into a hollow cylinder with one end open and the other end sealed, wherein the open end of the soft silicone tube is tightly socketed with the protruding cylinder of the glass container.

The protruding cylinder of the glass container is a hollow cylinder communicating with the inside of the glass container.

Preferably, a sealing component is provided at junction of the soft silicone tube and the glass container.

Preferably, the sealing component is sealant.

Preferably, the sealing component is a fastening ring.

Compared with the prior art, the beneficial effects that the present application can achieve are:

The magnetic fluid in the glass container is suspended in the carrier liquid, and under the influence of the magnetic force, the magnetic fluid dances, forming an ornamental product. When the glass container is affected by the magnetic coil and the temperature continues to rise, the mixing liquid in the glass container will continue to expand, and the expanded liquid will automatically flow into the hollow soft silicone tube. The intersection of the soft silicone tube and the glass is sealed, and the liquid will not flow out. After the liquid flows, the pressure in the glass container is released to achieve a decompression effect, so as to maintain a good dancing picture of the magnetic fluid and achieve the desired purpose of visual effects. Because the internal pressure of the glass container is released, it can ensure that the glass container will not be burst by the internal pressure.

### BRIEF DESCRIPTION OF DRAWINGS

FIG. 1 is a structural schematic diagram of the present application.

FIG. 2 is a side structural view of the present application.

Reference signs: 1. Glass container; 2. Soft silicone tube; 3. Sealing component; 4. magnetic fluid mixing liquid.

### DETAILED DESCRIPTION

In order to explain the overall concept of the present application more clearly, the following detailed description will be given by way of examples in combination with the accompanying drawings.

It is to be understood that the orientation or positional relationship indicated by the terms “center”, “longitudinal”, “transverse”, “length”, “width”, “thickness”, “top”, “bottom”, “front”, “rear”, “left”, “right”, “vertical”, “horizontal”, “inner”, “outer”, “Clockwise”, “counterclockwise”, “axial”, “radial” etc. are based on the orientation or positional relationship shown in the drawings, and are only for the convenience of describing the application and simplifying the description, rather than indicating or implying that the device or element referred to must have a particular orientation, be constructed and operate in a particular orientation, and thus should not be construed as limiting the present application.

In addition, the terms “first” and “second” are used for descriptive purposes only, and cannot be interpreted as indicating or implying relative importance or implicitly specifying the quantity of indicated technical features. Thus, a feature defined as “first” and “second” may explicitly or implicitly include one or more of these features. In the description of the present application, “a plurality of” means two or more, unless otherwise specifically defined.

In the description of the present application, unless otherwise specifically defined, the terms “arranged”, “connected” and “connecting” are to be interpreted broadly. For example, it can be a fixed connection, a detachable connection, or an integral connection; it can be a mechanical connection or an electrical connection; it can be directly connected, or indirectly connected through an intermediary, and can be internally connected between two elements or the interaction relationship between two elements. Those of ordinary skill in the art can understand the specific meanings of the above terms in this application in specific situations.

In the present application, unless otherwise clearly specified and limited, a first feature being “on” or “under” a second feature may mean that the first and second features are in direct contact, or that the first and second features are indirect contact through an intermediary. In the description of this specification, descriptions referring to the terms “one embodiment”, “some embodiments”, “example”, “specific examples”, or “some examples” mean that specific features, structure, material or characteristic described in connection with the embodiment or example are included in at least one embodiment or example of the present application. In this specification, the schematic representations of the above terms are not necessarily directed to the same embodiment or example. Furthermore, the described specific features, structures, materials or characteristics may be combined in any suitable manner in any one or more embodiments or examples.

### Embodiment

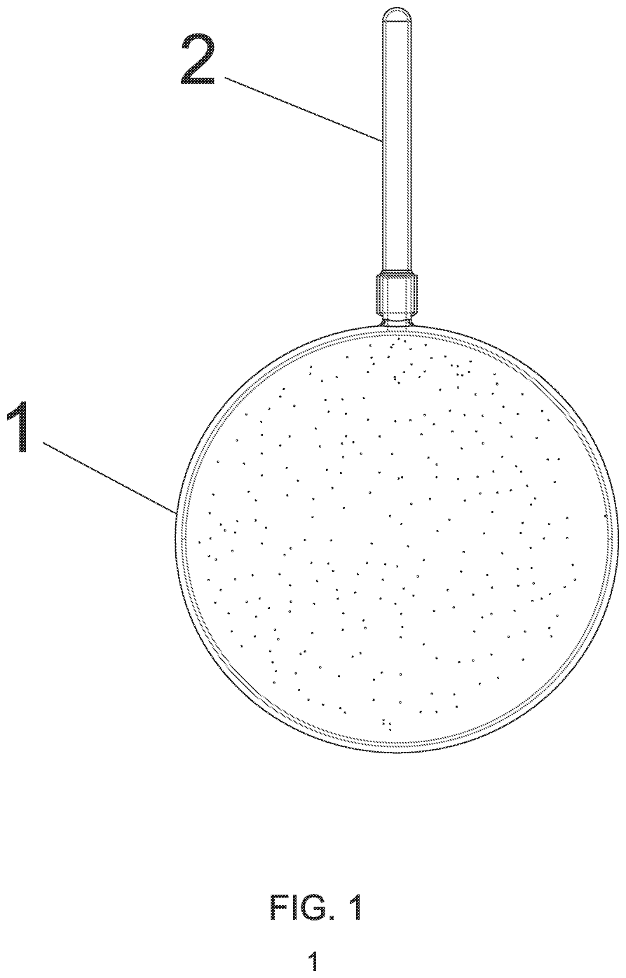

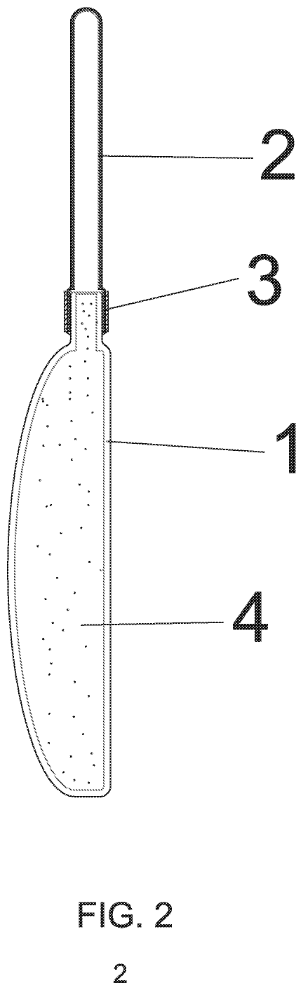

Please refer to FIG. 1 and FIG. 2, the present application provides a thermal decompression control device for glass containers for magnetic fluid mixing liquid, comprising a glass container 1, and an inside of the glass container 1 is filled with magnetic fluid mixing liquid 4, wherein an outer edge of the glass container 1 comprises an extended and protruding cylinder, and the glass container 1 is connected with a soft silicone tube 2 by the cylinder, wherein the soft silicone tube 2 is formed into a hollow cylinder with one end open and the other end sealed, wherein the open end of the soft silicone tube 2 is tightly socketed with the protruding cylinder of the glass container 1, wherein the protruding cylinder of the glass container 1 is a hollow cylinder communicating with the inside of the glass container 1. The thermal decompression control device of the glass container for magnetic fluid mixing liquid will be close to the magnetic coil, and the magnetic coil will generate magnetic force when the magnetic coil is in operation. The magnetic fluid mixing liquid 4 in the glass container 1 is affected by the magnetic force, which makes the magnetic fluid 4 produce a dancing effect, thus forming an ornamental product. When the glass container 1 is affected by the heat generated by the magnetic coil, the temperature continues to rise, the liquid inside the glass container 1 will continue to expand, and the expanded liquid will automatically flow into the soft silicone tube 2. The intersection of the soft silicone tube 2 and the glass is sealed, and the liquid will not flow out. After the liquid flows, the pressure in the glass container 1 is released to achieve a decompression effect, so as to maintain a good dancing picture of the magnetic fluid and achieve the desired purpose of visual effects. Because the internal pressure of the glass container 1 is released, it can ensure that the glass container will not be burst by the internal pressure.

As shown in FIG. 1 and FIG. 2, the present application discloses that a sealing component 3 is provided at junction between the soft silicone tube 2 and the glass container 1, and the sealing component 3 is a sealant.

As shown in FIG. 1 and FIG. 2, the present application discloses that a sealing component 3 is provided at junction between the soft silicone tube 2 and the glass container 1, and the sealing component 3 is a fastener ring.

As shown in FIG. 1 and FIG. 2, the overall shape of the glass container 1 shown in the schematic diagram of the present application is a disc-shaped profile, but the overall shape of the glass container 1 is not limited to the disc-shaped profile. It may be a cuboid profile, or a cylinder profile, or a hemispherical profile, or a sphere profile, or a pyramid profile. The principle of the device is applicable to glass containers with different shapes, but the shape of the glass container in the present application does not limit its protection scope.

The present application provides a thermal decompression control device for glass containers for magnetic fluid mixing liquid. The thermal decompression control device of the glass container for magnetic fluid mixing liquid will be close to the magnetic coil, and the magnetic coil will generate magnetic force when the magnetic coil is in operation. The magnetic fluid mixing liquid 4 in the glass container 1 is affected by the magnetic force, which makes the magnetic fluid 4 produce a dancing effect, thus forming an ornamental product. When the glass container 1 is affected by the heat generated by the magnetic coil, the temperature continues to rise, the liquid inside the glass container 1 will continue to expand, and the expanded liquid will automatically flow into the soft silicone tube 2. The intersection of the soft silicone tube 2 and the glass is sealed, and the liquid will not flow out. After the liquid flows, the pressure in the glass container 1 is released to achieve a decompression effect, so as to maintain a good dancing picture of the magnetic fluid and achieve the desired purpose of visual effects. Because the internal pressure of the glass container 1 is released, it can ensure that the glass container will not be burst by the internal pressure.

It should be noted that, in the present application, terms such as “comprising”, “including” or any other variation thereof are intended to cover a non-exclusive inclusion such that a process, method, article or apparatus comprising a set of elements includes not only those elements, but also includes other elements not expressly listed, or also includes elements inherent in such process, method, article or equipment. Without further limitations, an element defined by the phrase “comprising a . . . ” does not exclude the presence of additional identical elements in the process, method, article or apparatus comprising said element.

Although the embodiments of the present application have been shown and described, those skilled in the art can understand that various changes, modifications and substitutions can be made to these embodiments without departing from the principle and spirit of the present application. The protection scope of the present application is defined by the appended claims and their equivalents.

What is claimed is:

1. A thermal decompression control device for glass containers for magnetic fluid mixing liquid, comprising a glass container (1), and an inside of the glass container (1) is filled with magnetic fluid and carrier liquid (4), wherein the magnetic fluid is suspended in the carrier liquid, wherein an outer edge of the glass container (1) comprises an extended and protruding cylinder, and the glass container (1) is connected with a soft silicone tube (2) by the cylinder;
wherein the soft silicone tube (2) is formed into a hollow cylinder with one end open and the other end sealed, wherein the open end of the soft silicone tube (2) is tightly socketed with the protruding cylinder of the glass container (1),
wherein the protruding cylinder of the glass container (1) is a hollow cylinder communicating with the inside of the glass container (1).

2. The thermal decompression control device for glass containers for magnetic fluid mixing liquid according to claim 1, wherein a sealing component (3) is provided at junction of the soft silicone tube (2) and the glass container (1).

3. The thermal decompression control device for glass containers for magnetic fluid mixing liquid according to claim 2, wherein the sealing component (3) is sealant.

4. The thermal decompression control device for glass containers for magnetic fluid mixing liquid according to claim 2, wherein the sealing component (3) is a fastening ring.
